(19) United States
(12) Patent Application Publication
(10) Pub. No.: US 2014/0072772 A1
(43) Pub. Date: Mar. 13, 2014

(54) MARK STRUCTURE

(71) Applicants: Hon Hai Precision Industry Co., Ltd., New Taipei (TW); Fu Tai Hua Industry (Shenzhen) Co., Ltd., Shenzhen (CN)

(72) Inventor: ZHI-HUA LIU, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/969,712

(22) Filed: Aug. 19, 2013

(30) Foreign Application Priority Data
Sep. 10, 2012 (CN) 2012103317230

(51) Int. Cl. G09F 3/10

(52) U.S. Cl. CPC G09F 3/10
USPC 428/174; 428/192

(57) ABSTRACT

A mark structure is disclosed. The mark structure is adhered to a curved surface of an electronic device housing. The mark structure includes a main body and a fixing portion. The fixing portion outwardly extends from the main body, and is adhered to the curved surface of the housing. The fixing portion includes a plurality of elastic arms spaced from each other. Each elastic arm includes a deformable elastic portion.

### BACKGROUND

1. Technical Field

The present disclosure relates to mark structures, and particularly to a mark structure adhered to a curved surface.

2. Description of the Related Art

A mark structure, such as a LOGO or a light guiding post, is typically adhered to a housing of an electronic device for brand name marking or appealing appearances. The housing includes a curved surface. A mounting hole is defined in the curved surface. The mark structure includes a fixing portion and a main portion protruding from the fixing portion. The fixing portion includes a curved surface to match with the curved surface of the housing. The curved surface of the fixing portion is adhered to the housing by a double sided tape, and the main portion protrudes from the mounting hole and is received in the housing. However, a profile of the curved surface of the housing may be changed by inconstancy in the machining process, such that the curved surface of the mark structure cannot tightly adhere to the housing. Thus, the mark structure may be easily detached from the housing.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 shows one embodiment of a mark structure in a use state.

FIG. 2 is an isometric view of the mark structure of FIG. 1, adhered to an adhering member.

FIG. 3 is a cross-sectional view of the mark structure, taken along line of FIG. 2.

FIG. 4 is another cross-sectional view of the mark structure, taken along line IV-IV of FIG. 1.

### DETAILED DESCRIPTION

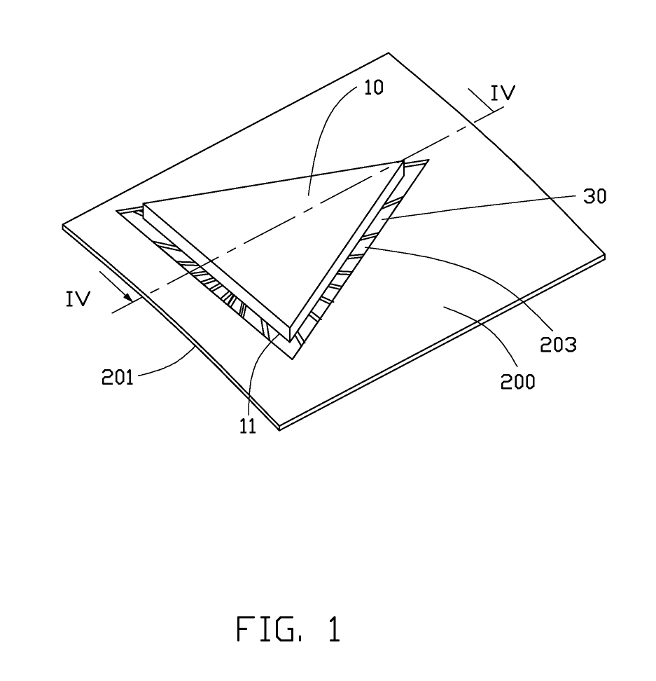

FIG. 1 shows an embodiment of a mark structure 100. The mark structure 100 is adhered to a curved surface 201 of the housing 200 of an electronic device (not shown). A mounting hole 203 is defined in the curved surface 201. The mark structure 100 includes a main body 10 and a fixing portion 30. The fixing portion 30 extends from a periphery of the main body 10 and surrounds the main body 10. The main body 10 partly protrudes from the mounting hole 203. The fixing portion 30 is adhered to the curved surface 201 by an adhering member 50.

In the embodiment, the main body 10 is substantially triangular, and includes a first surface 11, a second surface 13 opposite to the first surface 11, and a side surface 15 connecting the first surface 11 to the second surface 13. The second surface 13 protrudes out from the mounting hole 203. In other embodiments, the main body 10 is not limited to be triangular, and can be changed as needed. The adhering member 50 is a double sided tape.

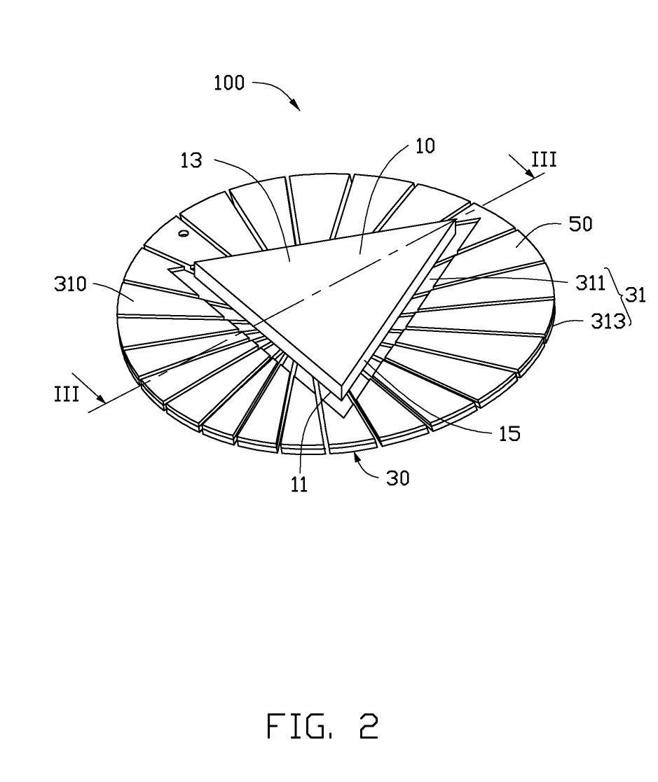

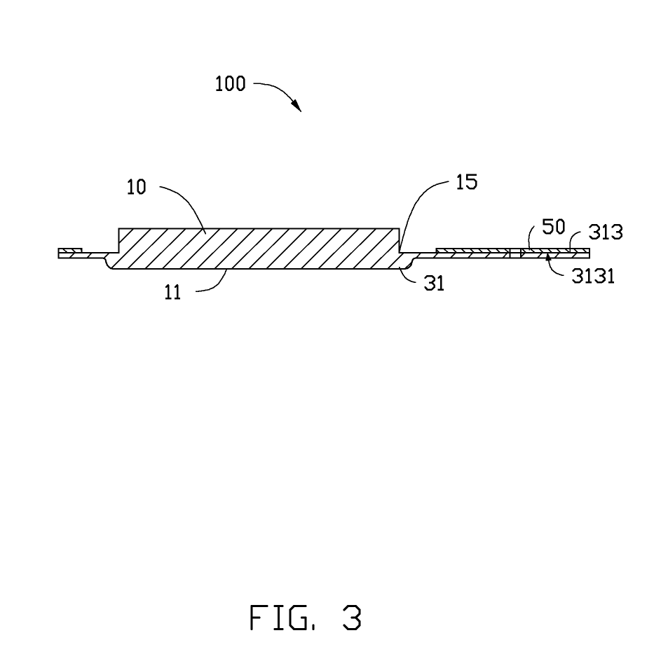

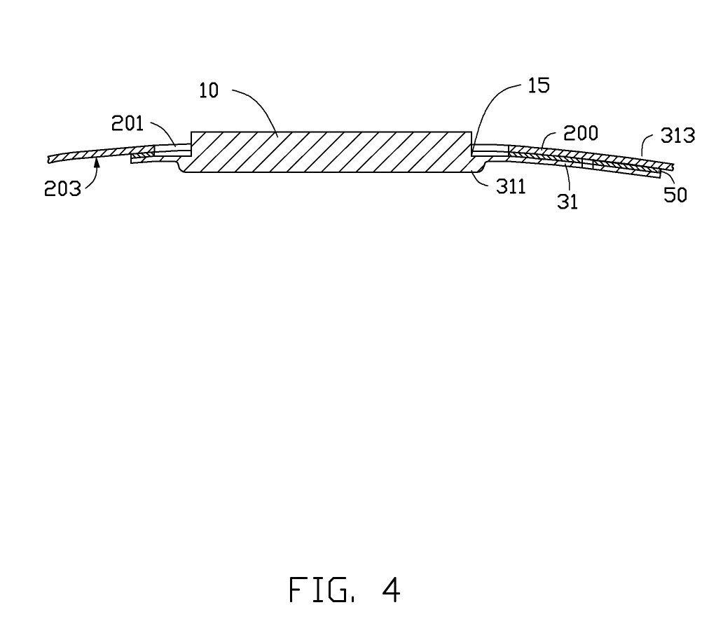

FIGS. 2 through 4 show the mark structure 100 in detail. The fixing portion 30 outwardly extends from an edge of the side surface 11 adjacent to the first surface 11. The fixing portion 30 includes a plurality of elastic arms 31 by cutting. The elastic arms 31 are spaced from each other. Each elastic arm 31 is deformable toward or away from the first surface 11. Each elastic arm 31 includes a connection portion 311 connected to the side surface 15 and an elastic portion 313 extending from a free end of the connection portion 311. The elastic portion 313 includes a fixing surface 3131. A plurality of fixing surfaces 3131 of the elastic arms 313 cooperatively forms a curved matching surface 310 matched with the curved surface 201 of the housing 200. The curved matching surface 310 of the fixing portion 30 is adhered to the curved surface 201 of the housing 200 by the adhering member 50. In the embodiment, the elastic arms 31 are made of stainless steel. In other embodiment, the elastic arms 31 can be made of other metal material, such as aluminum alloy, magnesium alloy, for example. The connection portion 311 can be omitted, and the elastic portion is directly connected to the main body 10.

In use, the adhering member 50 is adhered to the elastic portions 313 of the elastic arms 31. The mark structure 100 is placed on the curved surface 201 of the housing 200, and the main body 10 is inserted in the mounting hole 203, allowing the second surface 13 to protrude from the mounting hole 203. The elastic portions 313 of the elastic arms 31 with the adhering member 50 resist against and adhere to the curved surface 201.

Even if a profile of the curved surface 201 of the housing 200 is changed during manufacturing process, the elastic portions 313 may be deformed to match with the curved surface 201, such that the mark structure 100 can always tightly adhere to the curved surface 201 of the housing, and keeps stable.

It is to be understood, however, that even through numerous characteristics and advantages of the disclosure have been set forth in the foregoing description, together with details of the structure and function of the embodiments, the disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. A mark structure configured to be adhered to a curved surface, the mark structure comprising:
a main body; and
a fixing portion outwardly extending from the main body and being configured to be adhered to the curved surface, the fixing portion comprising a plurality of elastic arms spaced from each other, each of the plurality of elastic arms comprising an elastic portion, wherein the elastic portion is deformable, the elastic portion comprises a fixing surface configured to be adhered to the curved surface.

2. The mark structure of claim 1, wherein the fixing portion is made of metal.

3. The mark structure of claim 1, wherein the main body comprises a first surface and a side surface connected to the first surface, the each of the plurality of elastic arms further comprises a connection portion, the connection portion outwardly extends from an edge of the side surface adjacent to the first surface, the elastic portion extends from a free end of the connection portion.

4. The mark structure of claim 1, wherein a plurality of fixing surfaces of the plurality of elastic arms cooperatively forms a matching surface matched a profile of the curved surface.

5. A mark structure, comprising:
a main body; and
a fixing portion outwardly extending from a periphery of the main body, the fixing portion comprising a plurality of elastic arms spaced from each other, each of the plurality of elastic arms comprising an elastic portion, wherein the elastic portion is deformable.

6. The mark structure of claim 5, wherein the fixing portion surrounds the main body.

7. The mark structure of claim 5, wherein the main body comprises a first surface and a side surface connected to the first surface, the each of the plurality of elastic arms further comprises a connection portion, the connection portion outwardly extends from an edge of the side surface adjacent to the first surface, the elastic portion extends from a free end of the connection portion.

8. The mark structure of claim 5, wherein the fixing portion is made of metal.

9. The mark structure of claim 5, wherein the plurality of elastic arms cooperatively forms a curved matching surface.
